(19) United States
(12) Patent Application Publication
(10) Pub. No.: US 2025/0319567 A1
(43) Pub. Date: Oct. 16, 2025

(54) DUST REMOVAL DEVICE FOR A GRINDING MACHINE

(71) Applicant: Festool GmbH, Wendlingen (DE)

(72) Inventors: Erik SCHUESSLER, Leonberg (DE); Stefan TULODZIECKI, Neuhausen (DE); Michail LYUBOVITSKY, Wendlingen (DE)

(73) Assignee: Festool GmbH, Wendlingen (DE)

(21) Appl. No.: 19/046,656

(22) Filed: Feb. 6, 2025

(30) Foreign Application Priority Data
Feb. 9, 2024 (DE) 10 2024 103 665.6
May 21, 2024 (DE) 10 2024 114 134.4

(51) Int. Cl. B24B 23/02; B23Q 11/00

(52) U.S. Cl. CPC B24B 23/02; B23Q 11/0071

(57) ABSTRACT

A dust removal device, in particular dust collection device, for a hand-held machine tool, in particular a grinding machine or saw, has a tubular connection body for connecting to a tubular dust removal connector of the tool. A dust/air stream for conveying away dust from grinding machine operation can flow from a dust removal space to the device, via the connector. The body has a clamping mechanism for clamping to the connector with an activation element for activating it between release and clamping positions. An accommodation cross-section of the body for the connector is smaller in the clamping position for clamping connector to body than in the release position for removing device from connector. The element includes a pivot lever mounted to pivot about a pivot axis and angle, between a clamping activation position assigned to the clamping position and a release activation position assigned to the release position.

### CROSS REFERENCE TO RELATED APPLICATIONS

Applicant claims priority under 35 U.S.C. § 119 of German Application No. 10 2024 114 134.4 filed on May 21, 2024 and German Application No. 10 2024 103 665.6 filed on Feb. 9, 2024, the disclosures of which are incorporated by reference.

### BACKGROUND OF THE INVENTION

### 1. Field of the Invention

The invention relates to a dust removal device, in particular a dust collection device, for a hand-held machine tool, in particular a grinding machine or a saw, wherein the dust removal device has a tubular connection body for connecting to a tubular dust removal connector of the hand-held machine tool, wherein a dust/air stream for conveying away dust that occurs during operation of the grinding machine can flow out of a dust removal space to the dust removal device, by way of the dust removal connector, wherein the connection body has a clamping mechanism for clamping to the dust removal connector, wherein the clamping mechanism has an activation element for activation of the clamping mechanism between a release position and a clamping position, wherein an accommodation cross-section of the connection body for the dust removal connector in the clamping position, for clamping the dust removal connector to the connection body, is smaller than in the release position that is provided for removing the dust removal device from the dust removal connector.

### 2. Description of the Related Art

The dust removal device is configured, for example, as a dust collection mechanism having a dust container. The dust removal direction can also, however, form a suction hose or part of a suction hose. It is known, as such, that a dust collection mechanism can be fastened to an outlet connector of a grinding machine, using a clamping clip. The clamping clip is activated into its clamping position by means of a screw, but this is complicated. The operator needs a screwdriver, for example, in order to drive a screw that activates the clamping mechanism. Such activation is acceptable, for example, if the dust collection container or the dust collection device remains permanently on the hand-held machine tool, for example the grinding machine. This is not a problem, for example, if the dust collection container has an opening for emptying it, for example with a lid or the like, or if the dust collection container can be removed from the connection body, so as to empty it.

### SUMMARY OF THE INVENTION

It is the task of the present invention to make available an improved dust removal device.

To accomplish the task, it is provided, in the case of a dust removal device of the type stated initially, that the activation element comprises a pivot lever that is mounted so as to pivot between a clamping activation position assigned to the clamping position and a release activation position assigned to the release position, about a pivot axis, by a pivot angle.

In this regard, it is a basic idea that the activation of the clamping mechanism is clearly facilitated. The pivot lever can be activated by way of a small pivot path or pivot angle between the clamping activation position and the release activation position, something that can be done conveniently and easily.

In the status of the dust removal device when it is mounted on the hand-held machine tool, the dust removal connector, in particular a tubular body of the dust removal connector, is accommodated in the accommodation cross-section of the connection body or engages into the accommodation cross-section. The accommodation cross-section is defined and/or delimited, for example, by means of an interior space and/or an inside circumference wall and/or an inside circumference wall surface of the connection body, which body is tubular, in particular.

The accommodation cross-section is provided and/or configured for accommodating the connection body.

The accommodation cross-section and/or the inner cross-section and/or the inside circumference wall of the connection body is/are, in particular, circular, elliptical or polygonal.

It is advantageous if it is provided that the dust removal connector and/or the connection body is tubular or comprises a connection tube or a connection connector or is formed by a connection tube or a connection connector.

The connection body preferably has a slot that is narrower in the clamping position than in the release position. The slot is wider, for example, in the release position or release activation position than in the clamping activation position or the clamping position.

The pivot angle is preferably less than 300 degrees, further preferably less than 250 degrees. Even smaller pivot angles are easily possible, for example pivot angles that are less than 180 degrees, further preferably less than 150 degrees, and even further preferably less than 120 degrees. At this point, it should be mentioned that the pivot lever has already been adjusted from the clamping activation position into the release activation position when it has passed through the pivot angle, and can be pivoted even further, beyond the release activation position, but this does not necessarily mean that the accommodation cross-section of the connection body is wider. Consequently, therefore, the release position has already been reached after passing through the pivot angle, and the dust removal device can be removed from the dust removal connector.

It is preferred if the dust removal device has a spring mechanism, for example an elastic body, particularly in block shape, and/or a helical spring or the like, which puts stress on the clamping mechanism in the direction of the release position. The elastic body and the helical spring can be arranged one behind the other, for example, and/or be functionally switched in series. Consequently the pivot lever therefore acts in the direction of the clamping position, whereas the spring mechanism acts in the direction of the release position, in which the accommodation cross-section of the connection body is widened.

The spring mechanism thereby allows easier release of the dust removal device from the dust removal connector.

The clamping mechanism preferably comprises a clamping clip or is configured in the manner of a clamping clip. The clamping mechanism preferably comprises clamping legs that are adjusted toward one another in the clamping position, and clamping legs that are adjusted away from one another in the release position. The clamping legs can be adjusted toward one another and away from one another. The clamping clip or the clamping legs can form components that are separate from the connection body. Consequently, for example, the connection body can be surrounded by the clamping clip and/or by the clamping legs. However, it is also possible that the connection body integrally comprises the clamping clip or at least one clamping leg or the clamping legs. For example, the connection body can have a slot in the region of the clamping mechanism, so that clamping legs are formed in this way.

It is advantageous if free end regions of the clamping legs face one another or lie opposite one another. Preferably, a gap or slot is present between the free end regions of the clamping legs, which gap or slot is narrower in the clamping position than in the release position. The slot or gap can also no longer be present in the clamping position, i.e., the end regions of the clamping legs can lie against one another in the clamping position. A width of the slot can be changed or adjusted by means of activation of the activation element.

The clamping legs are preferably in one piece with a basic body, which is formed, in particular, by the connection body, on which the clamping legs are configured. This basic body or connection body preferably has such a resilient property or elasticity that the clamping legs are spring-loaded away from one another. For example, the basic body or connection body is tubular and has a slot that runs between the clamping legs and/or by means of which the clamping legs are formed.

The spring mechanism is preferably arranged between the clamping legs and puts stress on the clamping legs to move them away from one another. For example, the spring mechanism can comprise a spring body, for example an elastic body, in particular a block-shaped body, and/or a helical spring or the like, which spring body is arranged between the clamping legs. The spring body can be arranged, for example, on the tie rod that will be explained below, or the tie rod can pass through it. The spring body is arranged, for example, between the free end regions of the clamping legs, or assigned to the free end regions of the clamping legs and/or arranged on these free end regions, in particular attached to them.

The pivot lever is preferably movement-coupled with or connected to a tie rod, wherein the pivot lever activates the tie rod in the clamping activation position, in the sense of narrowing of the accommodation cross-section, and/or the tie rod activates clamping legs of the clamping mechanism toward one another, in the clamping activation position.

The tie rod is connected to the clamping legs, for example to free end regions of the clamping legs. For example, the tie rod passes through the clamping legs at their free end regions. For example, a distance, for example a slot or a groove, is provided between the free end regions of the clamping legs, beyond which distance the tie rod extends.

For example, the tie rod can be connected to one of the clamping legs, so that it can activate the latter with pull and advantageously also with push. A region of the tie rod that projects away from this clamping leg is movement-connected or movement-coupled to the pivot lever, for example. When the pivot lever then exerts pull activation on the tie rod, the pivot lever preferably acts on the one clamping leg, while the tie rod acts on the other clamping leg, so as to move the clamping legs toward one another in this way. Of course, the tie rod can also form a thrust element, i.e., the tie rod acts on one or both clamping legs not only in the direction of the clamping position, but also in the direction of the release position.

The pivot lever preferably comprises an activation contour for activating the clamping mechanism between the release position and the clamping position. For example, the activation contour can run eccentrically relative to the pivot axis or comprise an eccentric contour.

The pivot lever preferably has an accommodation contour for the connection body, which contour faces the connection body, into which contour the connection body engages in the clamping activation position. For example, the accommodation contour is rounded or configured in the manner of a trough, wherein the tubular connection body can engage into the trough or into the rounded accommodation contour with its outside circumference contour. Consequently the pivot lever, in the clamping activation position, lies as close as possible against the connection body and does not project away from the connection body.

The pivot lever preferably has a handle projection, which, in the clamping activation position, projects away from the connection body so as to be grasped by an operator and activated out of the clamping activation position into the release activation position. For example, the handle projection can run or be oriented inversely to the accommodation contour on the pivot lever.

It is advantageous if the dust removal device has a suction hose arranged on the connection body and flow-connected to the connection body, for a connection to a vacuum cleaner. The suction hose is arranged on the tubular connection body in a fixed manner, for example, or so as to rotate with reference to a longitudinal axis of the tube body. The connection body itself can therefore be mounted in a torque-proof manner, for example, on the dust removal connector of the hand-held machine tool, whereas the suction hose can rotate relative to the connection body, using the rotational bearing.

It is advantageous if it is provided that the dust removal device comprises a dust collection container for collecting dust. An accommodation space of the dust collection container is flow-connected to the connection body. Dust can be collected in the accommodation space. The dust collection container is air-permeable, for example, so that the dust/air stream can flow through the dust collection container, but the particles or the dust is/are retained in the accommodation space of the dust collection container.

It is advantageous if the dust collection container has a flexible dust container, for example made of woven textile or the like, as well as a support body for supporting the dust container in an accommodation position that holds the dust container stretched out or open or suitable for holding dust. The support body is rod-shaped, for example, and/or comprises a support rod or a rod contour. The support body can be flexibly resilient.

It is advantageous if it is provided that a part of the dust collection container that lies opposite the handle, in a position of the handle provided so that the handle can be grasped, does not have any section of the support body and/or is not directly supported by the support body, in such a manner that an operator can reach into a soft part of the dust collection container in the sense of displacement of the dust collection container when the handle is grasped.

An advantageous concept provides that the support body has a support body longitudinal section that extends away from the connection body, and a support body transverse section that runs transverse to the support body longitudinal section. The support body is arranged on the connection body in such a manner that the support body longitudinal section runs on a side that faces away from a handle and/or energy storage unit of the hand-held machine tool in the state when the dust removal device is mounted on the hand-held machine tool, and the support body transverse section faces the handle and/or energy storage unit. Consequently, therefore, an operator who grasps the handle or activates the energy storage unit, for example so as to attach it to the hand-held machine tool or remove it from the latter, can reach into a soft section of the flexible dust container without the support body being disturbed. For example, the support body is L-shaped. A longer part of the support body forms the support body longitudinal section, while a shorter part of the support body forms the support body transverse section.

It is advantageous if the connection body can be plugged onto the dust removal connector along a plug-in axis. Consequently, easy plug-in activation is possible. When the connection body is plugged onto the dust removal connector, the clamping mechanism can be adjusted, using the pivot lever, between the release position and the clamping position, so as to thereby fasten the dust removal device firmly to the dust removal connector.

The plug-in axis and the pivot axis of the pivot lever are preferably parallel to one another or have a slight angle relative to one another, which is maximally 5°.

Preferably at least one shape-fit contour is arranged on the connection body, for engagement into a counter-shape-fit contour of the dust removal connector or a counter-shape-fit contour arranged on the dust removal connector. The shape-fit contour and the counter-shape-fit contour preferably engage into one another in the state of the dust removal device when it is mounted on the hand-held machine tool.

The at least one shape-fit contour is a shape-fit contour separate from the free end regions of the clamping legs and/or a shape-fit contour arranged away from the free end regions.

The at least one shape-fit contour preferably comprises at least one shape-fit projection that projects into the accommodation cross-section of the connection body and/or beyond an inside circumference wall surface of the connection body. The dust removal connector, for example a tubular body of the same, engages into the accommodation cross-section or an interior space defined by the inside circumference wall surface, wherein then the or a counter-shape-fit contour is arranged on this tubular body. The inside circumference wall surface of the connection body, which is tubular, for example, delimits and/or defines, for example, the accommodation cross-section of the connection body. The shape-fit projection is configured, for example, in the manner of a cam. The counter-shape-fit contour has an accommodation depression, for example, for accommodating the shape-fit projection.

It is also possible that the at least one shape-fit contour projects outside of the accommodation cross-section, outward beyond the connection body, for example is arranged on the outside, on a tubular section of the connection body. For example, the shape-fit contour is arranged on an outside circumference of the connection body. This shape-fit contour can be, for example, the closure part explained below or a shape-fit contour that does not fulfill any function of a closure part.

The dust removal device, in particular the at least one shape-fit contour, preferably comprises a closure mechanism and/or closure part for an external air inlet of the hand-held machine tool, namely, for example, of the grinding machine, for letting external air into the dust removal space. The external air inlet is arranged next to the dust removal connector or upstream from the dust removal connector. Consequently, therefore, the closure part can fulfill two functions, for example, namely closing off the external air inlet, in whole or in part, when the dust removal device is arranged on the dust removal connector, and furthermore also producing a shape-fit connection between the dust removal device and the hand-held machine tool.

The closure mechanism comprises a closure part, for example, or is formed by a closure part.

The closure mechanism and/or closure part is provided and/or configured to close off a flow cross-section of the external air inlet, in whole or in part, in particular when the dust removal device is arranged on and/or attached to the hand-held machine tool.

A flow cross-section of the external air inlet can be closed off by means of the closure mechanism, in its closed position, completely or preferably by at least 90%, even more preferably by at least 95% or 97%.

The external air inlet can preferably be closed off completely, using the closure part, or can be closed off in an air-tight manner, so that no external air can flow in through the external air inlet.

However, it is also possible that the external air inlet can be closed off by means of the closure part, essentially but not completely. In this way, it is possible that at least a part of the external air inlet is open to flow, to such an extent that a slight amount of external air can flow into the external air inlet. By means of the closure part, it is preferably possible to cover and close off the external air inlet by at least 80%, preferably by at least 90%, even more preferably by at least 95% or 98%. It can advantageously be provided that when the external air inlet is covered and/or closed off by means of the closure part, in comparison with the external air inlet not being covered by the closure part, maximally still 20%, preferably still 15%, even more preferably still 10% and finally, even more preferably still 5% of a volume stream of the external air can flow in through the external air inlet. If, therefore, the closure part closes off and/or covers the external air inlet, at least 80-95% less external air, for example, gets through the external air inlet than when the external air inlet is not closed off or covered by the closure part.

It is advantageous if it is provided that the external air inlet is arranged away from the dust/air stream that flows through the dust removal connector and/or that the external air inlet does not have any flow connection to the dust/air stream that flows through the dust removal connector outside of the dust removal space and/or that the external air inlet is flow-connected to the dust removal connector by way of the dust removal space.

The closure part is configured, for example, as a closure wall.

The closure part is preferably configured and/or provided for the purpose of closing off the external air inlet completely, in an air-tight manner, when the closure part is arranged on the external air inlet. However, it is also possible that the closure part does cover the external air inlet, but does not close it off completely, in an air-tight or flow-tight manner, i.e., that the closure part does lie against or is arranged on the external air inlet, but nevertheless a small amount of external air can flow into the external air inlet, for example through a gap or slot between closure part and external air inlet.

It is advantageous if the at least one shape-fit contour forms an anti-rotation unit contour that counteracts rotation of the dust removal device on the dust removal connector, or prevents rotation of the dust removal device with reference to the dust removal connector. The anti-rotation unit can now be a precise anti-rotation unit or one that has little rotational play, i.e., it is not possible to rotate the dust removal device with reference to the dust removal connector, aside from the play that is necessary for plugging it onto the dust removal connector. It is also possible, however, that the anti-rotation unit permits a certain amount of rotational play, for example of maximally 10 degrees. In both cases, it is possible that a block-shaped dust collection container, for example, has a predetermined rotational position with reference to the dust removal connector, so that it does not touch or strike along the workpiece, for example, when the hand-held machine tool is in use.

Both a shape-fit contour that projects into the accommodation cross-section and one arranged outside of the connection body or of the accommodation cross-section of the connection body can serve as an anti-rotation unit or anti-rotation unit contour and/or have an anti-rotation unit contour. The anti-rotation unit contour holds the dust removal device on the dust removal connector in a torque-proof manner with reference to a longitudinal axis of the dust removal connector and/or of the connection body and/or of a plug-in axis along which the dust removal device can be plugged onto the dust removal connector.

It is advantageous if the connection body has a shape-fit contour, in particular one serving as an anti-rotation unit contour, at positions that are spaced apart from one another by their angle, with reference to the plug-in axis, preferably at least two positions that are spaced apart from one another by their angle, and/or in positions spaced apart at longitudinal intervals with reference to the plug-in axis, in each instance.

The dust removal device preferably has a plug-in guide for guiding the connection body on the dust removal connector in a torque-proof manner with reference to the plug-in axis. This torque-proof guidance can be in effect only during the plug-in process, for example, while it is not in effect during use of the clamping mechanism or in the clamping position. The anti-rotation unit can also be active in the clamping position, however. Here, too, it should be noted that the anti-rotation unit or the torque-proof guidance can allow a rotational play with reference to the plug-in axis, for example of maximally 10 degrees.

The at least one shape-fit contour, preferably during engagement into the counter-shape-fit contour of the hand-held machine tool, holds the dust removal device on the dust removal connector with shape fit, tightly with reference to the plug-in axis and/or torque-proof with reference to the plug-in axis. For example, the shape-fit contour and counter-shape-fit contour engage into one another in the clamping position. Consequently both things are possible, namely, for one thing, clamping fixation, for another thing also shape-fit fixation. It is advantageous if it is provided that the shape-fit contour and the counter-shape-fit contour are out of engagement in the release position and/or the connection body is opened up, in the release position, in such a manner that the shape-fit contour and the counter-shape-fit contour can be brought out of engagement.

The at least one shape-fit contour and/or the at least one counter-shape-fit contour preferably has/have a longitudinal shape-fit contour or longitudinal counter-shape-fit contour that runs with a directional component parallel to an axis, for example to the plug-in axis or to the longitudinal axis of the connection body or of the dust removal connector, respectively, or essentially or precisely parallel to the axis, which contours act, for example, as an anti-rotation unit with reference to the axis, for example the plug-in axis, when the longitudinal shape-fit contour and the longitudinal counter-shape-fit contour are in engagement with one another.

The at least one shape-fit contour and/or the at least one counter-shape-fit contour preferably has/have a transverse shape-fit contour or transverse counter-shape-fit contour that runs transverse to the plug-in axis or longitudinal axis of the connection body or of the dust removal connector, respectively, which contours act, for example, as an anti-rotation unit with reference to an axis, in particular the plug-in axis and/or the corresponding longitudinal axis of connection body or dust removal connector, when the transverse shape-fit contour and the transverse counter-shape-fit contour are in engagement with one another. The transverse shape-fit contour and/or the transverse counter-shape-fit contour are preferably oriented at a right angle or at an angle between 85 and 95° to the axis, for example to the plug-in axis and/or to the corresponding longitudinal axis of the connection body and/or of the dust removal connector. The anti-rotation unit can have a rotational play with reference to the plug-in axis, i.e., even when the transverse shape-fit contour and the transverse counter-shape-fit contour engage into one another, the connection body can rotate about the axis, for example the plug-in axis, relative to the dust removal connector, by a predetermined but limited rotational play. The rotational play amounts to, for example, maximally 20°, preferably maximally 15°, even further preferably maximally 10° or maximally 5°.

It is advantageous if the accommodation cross-section is essentially circular and/or has a homogeneous and/or planar inside circumference wall surface.

The at least one shape-fit contour projects beyond the inside circumference wall surface, for example.

Preferably it is provided that the at least one shape-fit contour that projects into the accommodation cross-section and/or the inside circumference wall surface can come or does come out of engagement with the counter-shape-fit contour in the release position of the clamping mechanism, so that the connection body can be removed from the dust removal connector along the plug-in axis. The connection body therefore has such an accommodation cross-section in the release position of the clamping mechanism that the at least one shape-fit contour that projects into the accommodation cross-section and/or the inside circumference wall surface is outside an envelope of the dust removal connector in the region of the counter-shape-fit contour, so that the shape-fit contour can be moved past the counter-shape-fit contour along the plug-in axis.

The accommodation cross-section of the connection body, into which the at least one shape-fit contour projects, is preferably the accommodation cross-section assigned to the clamping position.

### BRIEF DESCRIPTION OF THE DRAWINGS

In the following, an exemplary embodiment of the invention will be explained using the drawing. The figures show:

FIG. 1 a perspective slanted view of a hand-held machine tool having a dust collection container,

FIG. 2 the slanted view of the hand-held machine tool according to FIG. 1, but with a connected suction hose,

FIG. 3 the hand-held machine tool according to FIG. 2 from below,

FIG. 4 a side view of the hand-held machine tool according to the above figures, partly in section,

FIG. 5 a perspective slanted view of a section through a front part of the hand-held machine tool according to FIG. 1, approximately along a section line A-A in FIG. 1,

FIG. 6 a sectional view similar to FIG. 5, but through the hand-held machine tool according to FIG. 2 and directly from above, approximately along a section line B-B in FIG. 2,

FIG. 7 an exploded representation of the hand-held machine tool according to the above figures,

FIG. 8 a perspective slanted view of a dust/air wheel of the hand-held machine tool,

FIG. 9 a longitudinal section through a front part of the hand-held machine tool according to the above figures, approximately corresponding to the sectional representation according to FIG. 4,

FIG. 10 a bearing support, a motor bearing, and a drive motor of the hand-held machine tool,

FIG. 11 a perspective slanted view of a dust collection device having a clamping mechanism for being connected to the hand-held machine tool,

FIG. 12 a perspective slanted view of a suction hose having a clamping mechanism for being connected to the hand-held machine tool,

FIG. 13 a rear partial view of the hand-held machine tool according to the above figures, having the clamping mechanism of the dust collection container shown in FIG. 11 or 12, in the clamping position (wherein the dust collection container is not shown, for the remainder),

FIG. 14 the view according to FIG. 13, with the clamping mechanism in the release position,

FIG. 15 a variant of the hand-held machine tool according to the above figures, having a closure mechanism for closing off an external air inlet,

FIG. 16 a perspective detail view of the variant according to FIG. 15, wherein an upper and a rear part of the hand-held machine tool are not shown,

FIG. 17 a perspective detail view from below, of a variant of the hand-held machine tool having a further closure mechanism, approximately corresponding to a Detail D in FIG. 15,

FIG. 18 a sectional view through the detail according to FIG. 17, approximately along a section line C-C drawn in FIG. 6, with the closure mechanism in the closed position,

FIG. 19 the sectional view according to FIG. 18, but with the closure mechanism in the open position,

FIG. 20 the hand-held machine tool according to FIG. 1 with its top side laid down onto a substratum,

FIG. 21 the hand-held machine tool in the position according to FIG. 20, but without the energy storage unit and dust collection container, and

FIG. 22 the hand-held machine tool in the position according to FIG. 20, but from the front and without the dust collection container, and with a smaller disk tool.

### DETAILED DESCRIPTION OF PREFERRED EMBODIMENTS

A hand-held machine tool 10 according to the drawing is configured, for example, as a grinding machine 11. The hand-held machine tool 10 has a drive motor 12, the power take-off of which rotates about a motor axis M and drives a gear mechanism 13, for example an eccentric gear mechanism, an oscillation gear mechanism, or the like, which in turn drives a tool holder 14 rotationally and/or eccentrically and/or hypercycloidically.

The drive motor 12 is an electric drive motor. The drive motor 12 has, for example, a stator 12A as well as a rotor 12B.

The tool holder 14 rotates about a tool axis W or is driven or can be driven rotationally about a tool axis W.

The tool axis W and the motor axis M are, for example, eccentric to one another.

The gear mechanism 13 is or comprises, for example, an eccentric gear mechanism or eccentric bearing 13A.

The drive motor 12 and the gear mechanism 13 form a drive train 13B or at least parts of a drive train 13B, which is accommodated in a machine housing 15 of the hand-held machine tool 10.

The hand-held machine tool 10 is a hand-guided machine tool, i.e., a machine tool to be guided by hand, or that can be guided by hand by an operator. Accordingly, the operator can guide the hand-held machine tool freely along a workpiece surface WO, for example in a main working direction HA, toward the front, or counter to the main working direction HA, toward the rear, or transverse to the main working direction HA.

The machine housing 15 has a drive part 16 that accommodates the drive motor 12 and the gear mechanism 13, consequently the drive train. The drive part 16 has, for example, a motor mounting bracket 16A for accommodating the drive motors 12.

A handle section 17, which has or is formed by a hand rest, for example, is arranged on the drive part 16. The handle section 17 or the hand rest is suitable for being grasped by the hand of an operator and/or for allowing the hand of an operator to rest on it.

A handle 18 projects from the drive part 16, for example counter to the main working direction HA. The handle section 17 and the handle 18 are arranged, for example, on a front section or a front side 19 and a back or rear section or a rear side 20 of the machine housing 15 with reference to the main working direction HA.

The tool holder 14 and/or the tool axis W and/or the motor axis M are situated approximately in the region of a longitudinal center plane 23, which extends from the front side 19 to the rear side 20 of the hand-held machine tool 10. The handle section 17 is arranged on a top side 24 of the hand-held machine tool 10, while the tool holder 14 is arranged on an underside 25 that lies opposite the top side 24. The underside 25 is provided for guiding the hand-held machine tool 10 along the workpiece surface WO or lies opposite the workpiece surface WO during operation of the hand-held machine tool 10.

The hand-held machine tool 10 is preferably a battery-operated or rechargeable-battery-operated hand-held machine tool. The concepts explained below, regarding dust removal, regarding the configuration of the drive train, and regarding optimized attachment of a dust collection mechanism, could easily be implemented also in the case of a grid-connected hand-held machine tool. In this case, the hand-held machine tool 10 would have a connection cable, for example, for a connection to a power-supply network.

Slightly outside of the center with reference to the longitudinal center plane 23, an energy storage unit connector 26 for an electric energy storage unit 27, for example a rechargeable battery pack, is arranged.

The energy storage unit connector 26 is provided, for example, on a holding part 26A of the machine housing 15. The holding part 26A extends between the drive part 16 and an end region of the handle 18 that is at a distance from the drive part 16.

A reach-through opening 18A is provided between the handle 18 and the holding part 26A. A hand that holds the handle 18 can reach into the reach-through opening 18.

The tool holder 14 is arranged within and/or below a cover 30 that extends away from the drive part 16 to the underside 25 of the hand-held machine tool 10. The cover 30 delimits a dust removal space 31 that is provided for collecting and carrying away dust that is formed during machining of the workpiece surface WO.

For example, a disk tool 90, in particular a grinding tool, can be releasably fastened to the tool holder 14. For this purpose, the disk tool 90 has a drive holder 91, for example. The drive holder 91 and the tool holder 14 comprise, for example, bayonet contours and/or rotational entrainment contours and/or a screw connection or the like.

The disk tool 90 has a machining surface 92, for example a grinding surface or polishing surface, wherein the grinding surface can also be formed by means of a grinding agent that can be releasably attached to the disk tool 90. Inflow openings 93 into which air can flow are arranged on the machining surface 92. For example, an air stream charged with dust, in other words a dust/air stream S, can flow through the inflow openings 93 in the direction of the dust removal space 31, wherein the dust/air stream S can flow out at outflow openings 94 that are flow-connected to the inflow openings 93, on an installation side 95 of the disk tool 90 that lies opposite the machining surface 92 and is provided for installation on the hand-held machine tool 10.

A ring-shaped seal 31A or sealing cuff surrounds the dust removal space 31. The seal 31A is held, for example, on the machine housing 15 and lies against the installation side 95 of the disk tool 90. The outflow openings 94 are arranged in an interior space that is enclosed by the seal 31A.

It is possible that the dust removal space 31 is suctioned off, for example, using a vacuum cleaner STA. In this case, active production of a dust/air stream by means of the hand-held machine tool 10 is not necessary, but it is possible.

In the present case, however, the hand-held machine tool 10 or grinding machine 11 has an active production of the dust/air stream or is configured for active production of the dust/air stream. A dust/air wheel 32 that is driven or can be driven by the drive motor 12 is arranged within the dust removal space 31. For example, the dust/air wheel 32 is arranged on the power take-off of the drive motor 12.

The dust/air wheel 32 can support the dust/air stream S even if the vacuum cleaner STA is connected to the dust removal connector 33.

The dust/air wheel 32 therefore produces a dust/air stream S or supports its flow.

The dust/air wheel 32 is connected, in a torque-proof manner, to a motor shaft 12C of the drive motor 12, which shaft represents the power take-off of the drive motor 12. The drive motor 12 or the motor shaft 12C rotates in a direction of rotation DR.

The dust/air wheel 32 rotates in the direction of rotation DR, so that the dust/air stream S flows through the dust removal space 31 in the direction of rotation DR and flows into the dust removal connector 33.

The dust/air wheel 32 and optionally the vacuum cleaner STA produce an air stream that draws in particles, dust or the like, which occurs, for example, during machining of the workpiece surface WO, through the inflow openings 93 of the disk tool 90. The dust/air stream S produced in this manner flows out of the outflow openings 94 into the dust removal space 31, where the dust/air wheel 32 conveys it further in the direction of the dust removal connector 33.

The dust removal connector 33 is configured, for example, as a removal connection tube 34 or a removal connection piece 35, or has a connection tube 34 or a connection piece 35.

The dust removal connector 33 is preferably arranged approximately tangentially with reference to the dust/air wheel 32.

It is advantageous if the dust removal connector 33 is arranged outside the center with reference to the longitudinal center plane 23, for example close to the longitudinal side 22. Therefore the dust/air or the dust/air stream S flows out of the dust removal space 31 eccentrically relative to the tool axis W and tangentially to the same.

A dust removal device 50 can be connected to the dust removal connector 33.

Fundamentally, the hand-held machine tool 10 or grinding machine 11 can also be operated without a dust removal device 50, wherein then the dust/air stream S is blown out into the environment by way of the dust removal connector 33.

The dust removal device 50 is, for example, a dust removal device 50A in the form of a suction hose 70A or a dust removal device 50B in the case of a dust collection device 70.

Both dust removal devices 50A and 50B can pick up dust that flows through the dust removal connector 33. For example, the vacuum cleaner STA can pick up dust. Furthermore, the dust collection device 70 can collect dust.

Both dust removal devices 50A and 50B can optionally be connected to the dust removal connector 33 and, for this purpose, have a tubular connection body 51A or 51B. The connection bodies 51A or 51B can be plugged onto the dust removal connector 33, for example the removal connection tube 34, along a plug-in axis ST, or pulled off from the dust removal connector 33 by means of a pulling movement.

Both dust removal devices 50A and 50B are also referred to, in general, as a dust removal device 50 in parts of the following description.

The connection bodies 51A, 51B are also referred to, in general, as connection bodies 51, in particular if the same or similar components are present in both the dust removal devices 50A, 50B or connection bodies 51A, 51B.

The connection bodies 51A and 51B are equipped with clamping mechanisms 52 with which the dust removal devices 50A and 50B can be clamped onto the dust removal connector 33.

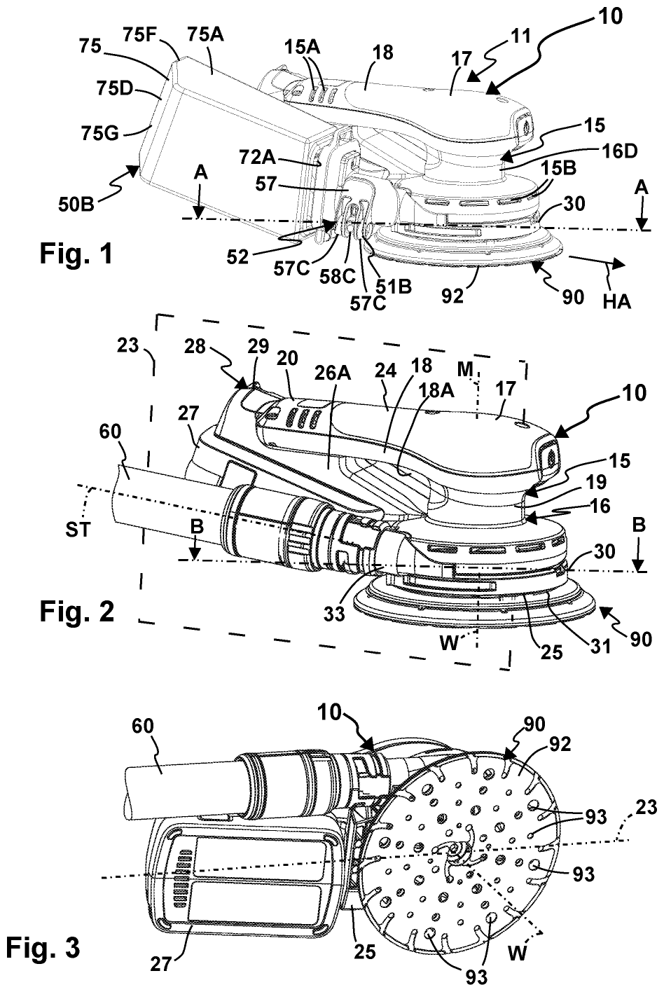

In the case of the connection body 51A, a variant shown in FIGS. 2 and 3 is also possible, which makes do without a clamping mechanism 52. In particular, this embodiment without a clamping mechanism 52 is optionally conceivable if the following optional measure of a shape-fit contour is provided on the tubular connection body 51A.

Furthermore, as an optional measure, at least one shape-fit contour 56A is provided, which projects radially inward into the connection body 51A or 51B and can come into engagement with at least one counter-shape-fit contour 36 on the connection tube 34 or connection piece 35.

For example, one, two or more shape-fit contours 56A can be provided on opposite sides and/or at an angular distance relative to a longitudinal expanse or longitudinal expanse axis of the connection body 51A or 51B. As an example and schematically, two shape-fit contours 56A are drawn in, in the case of the connection body 51B, wherein the angle position and/or the longitudinal distance with reference to the plug-in axis ST of the shape-fit contours 56A relative to one another is shown only schematically and should be understood as an example. In particular, the shape-fit contour 56A that is on the right in the drawing is shown close to the gap or slot 54B, so that it can be seen.

The at least one counter-shape-fit contour 36 is arranged radially on the outside, outside of a flow cross-section of the dust removal connector 33. For example, the counter-shape-fit contour 36 is configured as an arrangement of shape-fit holders and/or shape-fit projections or the like and/or it comprises such an arrangement. The at least one counter-shape-fit contour 36 comprises ribs, projections or the like, for example, which project beyond an outside circumference wall surface of the dust removal connector 33.

The at least one shape-fit contour 56A comprises one or more shape-fit projections 56V, for example. The at least one shape-fit contour 56A and/or the shape-fit projections 56V projects or project, for example, beyond an inside circumference wall surface 51W of the connection body 51.

The inside circumference wall surface 51W is configured, for example, as an essentially round inner wall surface. The inside circumference wall surface 51B delimits the holder cross-section 55, for example.

The at least one counter-shape-fit contour 36 comprises, for example, a depression 36V, and the shape-fit contour 56A comprises, for example, a shape-fit projection 56V for engagement into the depression 36V.

When the at least one shape-fit contour 56A engages into the at least one counter-shape-fit contour 36, the dust removal device 50 is fixed in place, for example, counter to the plug-in axis ST along which the dust removal device 50 can be plugged onto the dust removal connector 33, so that it cannot be pulled out.

The at least one shape-fit contour 56A and the at least one counter-shape-fit contour 36 advantageously form an anti-rotation unit, in particular in connection with a shape-fit contour 56B that will still be explained in detail below, which contour is provided, in the case of the dust collection device 70, on the connection body of the device or close to the connection body 51B of the device.

A particularly good hold of the dust removal device 50 on the dust removal connector 33 is made possible by the clamping mechanism 52. The clamping mechanism 52 is adjustable between a clamping position KS, in which a holder cross-section 55 of the connection body 51 is narrowed, and a release position FS, in which the holder cross-section 55 is so great that the dust removal device 50 can be removed from the dust removal connector 33 along the plug-in axis ST.

It is advantageous if the holder cross-section 55 is so large, in the release position FS, that the shape-fit contour 56A can also come out of engagement with the counter-shape-fit contour or the counter-shape-fit contours 36. The shape-fit contour 56A is configured, for example, as a shape-fit projection that projects into the holder cross-section 55.

The shape-fit contour 56A comprises transverse shape-fit contours 56Q that run transverse to the plug-in axis ST. The counter-shape-fit contours 36 comprise transverse counter-shape-fit contours 36Q that run transverse to the plug-in axis ST. When the dust removal connector 33 engages into the connection body 51A or 51B and the transverse shape-fit contours 56Q and the transverse counter-shape-fit contours 360 engage into one another, the connection body 51A, 51B is held on the dust removal connector 33, with reference to the plug-in axis ST, so that it cannot be pulled out.

The shape-fit contour 56A also comprises longitudinal shape-fit contours 56L that run parallel or precisely parallel to the plug-in axis ST with a directional component relative to the plug-in axis ST. The counter-shape-fit contour 36 that corresponds to this comprises longitudinal counter-shape-fit contours 36L that run parallel or precisely parallel to the plug-in axis ST with a directional component relative to the plug-in axis ST. When the dust removal connector 33 engages into the connection body 51A or 51B and the longitudinal shape-fit contours 56L and the longitudinal counter-shape-fit contours 36L engage into one another, the connection body 51A, 51B is held on the dust removal connector 33 so as not to rotate with reference to a rotation about the plug-in axis ST.

The longitudinal counter-shape-fit contours 36L and the transverse counter-shape-fit contours 36Q delimit, for example, the at least one depression 36V. Preferably, multiple depressions 36V are provided, which advantageously have a longitudinal distance with reference to the plug-in axis ST that essentially corresponds to a longitudinal axis of the dust removal connector 33, and/or have an angular distance with reference to the plug-in axis ST.

It is also possible that in the release position FS, the holder cross-section 55 is so great that the shape-fit contour 56A can rotate relative to the at least one shape-fit contour 56, so that the shape-fit contours 56 and 56A can be brought into such a rotational position that they can be displaced along the plug-in axis ST, past one another.

The clamping mechanism 52 has a clamping clip 53.

The clamping clip 53 can be formed, for example, by means of sections of the connection body 51A or 51B.

The clamping clip 53 can also be, in a manner not shown, a clamping clip that surrounds the connection body 51A or 51B and is separate from the connection body 51A or 51B, for example in the manner of a clamping brace.

The clamping clip 53 has clamping legs 54, for example, which narrow the holder cross-section 55 in a position when they are moved toward one another, and increase the holder cross-section 55 in a position when they are moved away from one another.

Free end regions 54C of the clamping legs 54 lie opposite one another, wherein a slot or gap 54B is formed between the end regions 54C, which slot or gap is smaller in the clamping position KS than in the release position FS.

An activation element 57X in the form of a pivot lever 57 serves to activate the clamping mechanism 52. The pivot lever 57 is mounted on the connection body 51 or close to the connection body 51 so as to pivot about a pivot axis SA, using a pivot bearing 57A.

It is advantageous if the pivot axis SA is parallel or essentially parallel, i.e., deviating at an angle of maximally 5°, relative to the plug-in axis ST.

For example, the pivot bearing 57A has an axis body or multiple axis bodies 57B, which are in engagement with bearing holders 57C of the pivot lever 57.

Consequently, therefore, the pivot lever 57 is mounted on the axis body 57B, using the bearing holders 57C, so as to pivot about the pivot axis SA.

The pivot lever 57 has a pivot arm 57D that can be grasped by an operator, which arm projects away from the pivot bearing 57A. The pivot arm 57D has an activation contour 57E in the region of the pivot bearing 57A, for example close to the bearing holder 57C. The activation contour 57E comprises an eccentric contour 57F that runs eccentrically relative to the pivot axis SA. Therefore when the pivot lever 57 is switched between a release activation position FB, assigned to the release position FS, in which the pivot lever 57 projects away from the connection body 57, into a clamping activation position KB that is assigned to the clamping position KS, sections of the eccentric activation contours 57B that are eccentrically farther away from the pivot axis SA increasingly come into engagement with a support part of the connection body 51 that is provided to support the activation contours 57B, so as to activate a tie rod 58 and/or adjust it linearly. The support part of the connection body 51 is provided, for example, on the outside circumference of the connection body 51 or of the tubular body, or formed by this outside circumference.

The tie rod 58 passes through the two clamping clips 53 in the region of the free end regions of the clamping legs 54. The tie rod 58 has a bolt section 58A, for example, which extends between a support head 58B and an entrainment head 58C. The bolt section 58A passes through passage openings 54A on the free end regions of the clamping legs 54.

The support head 58B supports itself, on the outside, on the clamping leg 54 that is farther away from the pivot lever 57. The entrainment head 58C supports itself on the axis body 57B, close to the pivot lever 57, which body has a holder 57I through which a bolt section 58A passes.

Therefore when the eccentric contour 57C supports itself on the connection body 51 during activation of the pivot lever 57 from the release activation position FB into the clamping activation position KB, a pulling force ZK acts on the tie rod 58, by means of which force the support head 58B is activated in the direction of the pivot lever 57, and thereby the holder cross-section 55 narrows, so that the connection body 51A or 51B becomes wedged in place by the dust removal connector 33, for example the outside circumference of the connection tube 34. As a result, an optimal clamping fit and hold of the corresponding dust removal device 50A, 50B on the dust removal connector 33 comes about.

When the clamping mechanism 52 is moved from the clamping position KS into the release position FS, there is the option, for example, that the tie rod 58 acts in the sense of a thrust element, for example using the support head 58B. Specifically, when the support head 58B or an entrainment contour arranged close to it entrains the clamping leg 54 on which the support head 58B is arranged, away from the other clamping leg 54 that is close to the entrainment head 58C, the two clamping legs 54 are moved away from one another in the sense of an increase in size of the holder cross-section 55, for example by means of a thrust force SK.

Alternatively or supplementally to activation of the clamping mechanism 52 from the clamping position KS in the direction of the release position FS, a spring mechanism 57J can also be provided, for example an elastic, block-shaped body, a helical spring or the like. The spring mechanism 57J is arranged, for example, between the clamping legs 54, i.e., their free end regions, and supports itself on the clamping legs 54. The bolt section 58A of the tie rod 58 passes through the spring mechanism 57J, for example.

The pivot arm 57C has a holding contour 57G, for example a trough-like depression, into which the connection body 51 engages in the clamping activation position KB and/or in which the connection body 51 is accommodated in the clamping activation position KB. Thereby the pivot arm 57D nestles against the connection body, so to speak, i.e., against its tubular shape, so to speak. In the clamping activation position KB, however, a handle projection 57H projects away from the connection body 51, suitable for being grasped by an operator, so that the operator can conveniently grasp the pivot lever 57 at the handle projection 57H to activate it and/or to pivot it in the direction of the release activation position FB.

The connection body 51B of the dust collection device 70 is arranged on a carrier body 71, which serves to carry a dust collection container 75. The dust collection container 75 is held on a further carrier body 72. The carrier bodies 71, 72 can be adjusted relative to one another, for example mounted so as to pivot on one another, for example using a pivot bearing 73. Both carrier bodies 71 and 72 have passage openings 71A and 72A for the dust/air stream S, wherein the passage opening 71A of the carrier body 71 is flow-connected to the connection body 51. When the carrier bodies 71, 72 are adjusted to be away from one another, the passage opening 72A of the dust collection container 75, which is clearly larger as compared to the passage opening 71A, and through which the dust collection container 75 can be emptied, is released. The carrier body 71 therefore forms a lid, for example, for the passage opening 72A of the carrier body 72.

It is also possible, however, to remove the dust collection device 70 from the dust removal connector 33 in order to empty it, so that dust retained in the dust collection container 75 can be emptied through the connection body 51B.

The carrier bodies 71, 72 can be fixed in place on one another using a fixation mechanism 74, for example a clamping mechanism, locking mechanism or the like, so that they lie flat against one another and a flow connection exists between the connection body 51 and the dust collection container 75, but the passage opening 72A is closed off. The fixation mechanism 74 can also be referred to as a carrier body fixation mechanism. Accordingly, the clamping mechanism or locking mechanism can be a carrier body clamping mechanism or carrier body locking mechanism.

The dust collection container 75 has a cubical or block-shaped form. For example, the dust collection container 75 has side walls 75A, 75B that lie opposite one another and can form upper and lower side walls, for example. Longitudinal side walls 75C extend between the side walls 75A, 75B. The carrier body 72 is arranged on a front wall 75D, for example. The dust collection container 75 is delimited or closed off by means of a rear wall 75E, on a side that faces away from the carrier body 72. The rear wall 75E can have sections 75F and 75G that are angled relative to one another, for example. Consequently, therefore, no opening is present on the dust collection container 75, except for the opening on the carrier body 72 or the connection body 51.

The dust collection container 75 preferably consists of a filter material, for example textile material or the like.

A support body 77, for example made of wire or the like, serves to hold the dust collection container 75 in an open or elongated shape. The support body 77 is preferably arranged in the interior of the dust collection container 75. Support body sections of the support body 77 preferably lie approximately in the region of inner edges of the dust collection container 75. It is advantageous if the dust collection container 75 is held open by the support body 77.

The support body 77 is held on the carrier body 72 and extends away from the latter with a support body longitudinal section 77A.

In the region of the rear wall 75D, a support body transverse section 77B of the support body 77 is provided, which section projects away from the support body longitudinal section 77A. The carrier body 72 and the support body transverse section 77B, together with the support body longitudinal section 77A that connects the two components, form a U-shaped form. A support body section 77C that projects away from the support body transverse section 77B toward the side wall 75B, which section is connected to the carrier body 72 using a support body section 77D and a support body section 77E, serves for further support of the dust collection container 75. The support body sections 77B and 77D run approximately parallel to one another, as do the support body sections 77A and 77D. For example, the support body sections 77A and 77B as well as the support body sections 77D and 77E are approximately L-shaped.

On the side of the dust collection container 75 that is assigned to the handle 18, no element of the support body 77 is provided, so that an operator, if he grasps the handle 18 and/or fastens the energy storage unit 27 onto the energy storage unit connector 26 or removes it from the latter, can grasp a soft section 75M of the dust collection container 75, so to speak, without the support body 77 being in the way.

It is easy to plug the dust collection device 70 onto the dust removal connector 33, in that a plug-in guide 80 and/or an anti-rotation unit contour 81 is/are present so as to guide and hold the dust collection device 70 on the dust removal connector 33 so as to prevent rotation with reference to the plug-in axis ST.

The plug-in guide 80 comprises a plug-in guide contour 80A. The plug-in guide contour 80A and the anti-rotation unit contour 81 are arranged on the dust collection device 70, in particular on its connection body 51B.

A plug-in guide contour 80B that interacts with the plug-in guide contour 80A as well as an anti-rotation unit contour 81B that interacts with the anti-rotation unit contour 81 are arranged on the dust removal connector 33. For example, the plug-in guide contour 80B and the anti-rotation unit contour 81B are formed by an end-face side or end-face wall that surrounds the external air inlet 40.

In the case of the suction hose 70A, a firm hold that can be achieved using the clamping mechanism 52, for example, makes it possible that an operator can grasp the suction hose 70A, if necessary, which hose is connected to the connection body 51A, so as to move the grinding machine 11 along the workpiece surface WO. The suction hose 70A has the connection body 51A at its one longitudinal end and a connection body 51C at a longitudinal end opposite to the first, to produce a connection to the vacuum cleaner STA.

Also in the case of the dust collection device 70, the clamping seat of the connection body 51B on the dust removal connector 33 proves to be advantageous, because rapid replacement or rapid exchange of the dust collection device 70 is easily possible. In particular, in this way an external air inlet 40 that will be explained below can also be closed off at the same time, by means of the dust removal device 50B, which inlet remains open when the dust removal device 50A or the suction hose 70A is connected.

The external air inlet 40 is arranged next to the dust removal connector 33 and close to the dust removal connector 33, and allows external air F to flow into the dust removal space 31. The external air inlet 40 is therefore arranged on the rear side 20 of the machine housing 50, seen with reference to the main working direction HA.

An external air channel 40A extends on the rear side 20 of the machine housing 50 and/or on the rear side of the dust removal space 31, on which channel the external air inlet 40 is arranged. The external air inlet 40 and an inflow opening 40B for flow of external air F into an accommodation chamber 32A, in which the dust/air wheel 32 is arranged, are flow-connected to one another by way of the external air channel 40A.

External air F that flows in through the external air inlet 40 flows through the external air channel 40A and flows into the dust removal space 31 by way of the inflow opening 40B.

It is advantageous if the external air channel 40A extends essentially over the entire transverse width or at least 50% or 60% of the transverse width of the dust removal space 31 and/or of the machine housing 15 in the region of the dust removal space 31, transverse to the longitudinal center plane 23.

While the dust removal connector 33 runs parallel or at an inclination of less than 30°, preferably less than 20°, even further preferably less than 10° relative to the longitudinal center plane 23, the external air inlet 40 runs transverse to the longitudinal center plane 23, for example approximately transverse at a right angle.

It is advantageous if the placement of the external air inlet 40 is arranged in such a manner that the external air F that flows into the external air inlet 40 flows almost entirely rotationally through the dust removal space 31 and, in this regard, picks up dust and particles before it flows into the dust removal connector 33 as the dust/air stream S. In any case, the dust/air wheel 32 can convey the external air F that flows in through the external air inlet 40 through almost the entire dust removal space 31, namely within the scope of a rotational movement or a flow movement that flows around the tool axis W, before the dust/exhaust air stream S flows out of the dust removal space 31 through the dust removal connector 33.

A flow of external air F through the external air inlet 40 is desirable, in particular, if the suction hose 70A and thereby the vacuum cleaner STA is connected. As a result, an undesirable partial vacuum situation is avoided, i.e., a sufficient dust/air stream S can always flow through the dust removal connector 33, without the vacuum cleaner STA or a flow measurement mechanism or pressure measurement mechanism that is present there determining an excessive partial vacuum, which would lead to shut-off of the vacuum cleaner STA. If the vacuum cleaner STA conveys an overly low dust/air stream S, there is the risk that dust could get into the surroundings of the hand-held machine tool 10 or grinding machine 11, to an unacceptable extent. The vacuum cleaner STA should therefore be able to produce the dust/air stream S as constantly as possible.

If, in contrast, the dust collection device 70 is connected to the dust removal connector 33, the external air F that flows into the external air inlet 40 would reduce the conveying power of the dust/air wheel 32, so that the dust/air stream S could have an overly slight extent. Therefore it is advantageous to close off the external air inlet 40 completely or at least partially when the dust collection device 70 is arranged on the dust removal connector 33.

The dust collection device 70 has a closure part 42A that serves for closing off the external air inlet 40 and forms a component of a closure mechanism 41A. The closure part 42A can basically be provided and configured for closing the external air inlet 40 off completely and/or in an air-tight manner. However, it is also possible that the closure part 42A does cover the external air inlet 40 but does not close it off completely or in an air-tight manner. Consequently, therefore, a small amount of external air can flow in through the external air inlet 40, even if the external air inlet 40 is covered by the closure part 42A. For example, a narrow slot can be present between an outside circumference of the closure part 42A and a contour or wall of the external air inlet 40 that runs next to the closure part 42A, through which slot external air can still flow into the external air inlet 40, even if this is only a small amount of external air.

The plug-in guide contour 80A and/or the anti-rotation unit contour 81 of the dust collection device 70 is/are advantageously formed or made available by the closure part 42A or is/are arranged on the closure part 42A. It is also possible that the closure part 42A forms the plug-in guide contour 80A and/or the anti-rotation unit contour 81.

When the dust collection device 70 is being connected to the dust removal connector 33, the external air inlet 40 should be closed. The closure part 42A already gets in front of the external air inlet 40 when the dust collection device 70 is being plugged onto the dust removal connector 33, and closes this inlet off.

The closure part 42A has, for example, a wall-like form and closes off the external air inlet 40 when the dust collection device 70 has been fastened onto the dust removal connector 33. At the same time, the closure part 42A forms the shape-fit contour 56B that has already been indicated and represents the anti-rotation unit contour 81 or shape-fit contour that acts at least on rotation with regard to the plug-in axis ST. Consequently, the plug-in guide contour 80B on the external air inlet 40 forms a counter-shape-fit contour 36B for the shape-fit contour 56B.

It is also advantageous, however, both in the case of the embodiments shown in the drawing and in each grinding machine according to the invention, if a closure mechanism can be used to close off an external air inlet independently of the connection of a dust collection container and/or if a closure mechanism allows setting the flow cross-section of the external air inlet, in other words, for example, makes a type of setting valve available or comprises a setting valve. Using such a closure mechanism, not only can the external air inlet be opened completely or closed completely, but it can also assume intermediate positions between an open position and a closed position.

A closure mechanism 41B, which serves for closing off an external air inlet 140, serves for such greater flexibility with regard to closing off an external air inlet. The external air inlet 140, like the external air inlet 40, is arranged on the rear side 20 of the grinding machine 11. However, the external air inlet 140 extends approximately beyond a transverse width of the rear side 20 and passes through the longitudinal center plane 23. The external air inlet 140 is open toward the underside 25 and/or in an orientation toward the machining surface 92 of the disk tool 90, and can therefore suction dust out of the surroundings of the hand-held machine tool 10 and of the grinding machine 11, into the dust removal space 31. If, for example, dust still remains on the workpiece surface WO when the grinding machine 11 is guided in the main working direction HA, this dust can be drawn in by way of the external air inlet 140. Consequently, a kind of “vacuum cleaner function” exists here.

The external air inlet 140 can also be closed, if necessary, for example when using the dust collection device 70. For this purpose, a closure mechanism 41B is provided, which has a closure link 42B, which is suitable for closing off or opening the external air inlet 140. The closure link 42B is configured, for example, in the manner of a roller, or formed by a rotating body 43. The closure link 42B is arranged next to the external air channel 40A or arranged on the external air channel 40A. It is advantageous if the closure link 42B extends approximately over the entire longitudinal expanse of the external air channel 40A.

The closure link 42B or the rotating body 43 is mounted on a bearing holder 44 of the machine housing 15, wherein the former or the latter can be adjusted between an open position OP, in which the external air inlet 140 is open, and a closed position SP, in which the external air inlet 140 is closed.

The closure link 42B has, for example, a cylindrical circumferential wall or closure wall 42C, which can be adjusted by means of rotating the closure link 42B in front of the inflow opening 40B, by way of which the external air F can flow into the accommodation chamber 32A, wherein then the closure wall 42C closes off the inflow opening 40B, and can be adjusted away from the inflow opening 40B, so that the inflow opening 40B is free to allow external air F to flow through. Intermediate positions of the closure link 42B are possible, in which the closure wall 42C only partially closes off the inflow opening 40B.

When the closure link 42B is in the open position OP, external air F can flow through the closure link 42B through an inflow opening 42D and an outflow opening 42E. In this open position OP, the inflow opening 42D lies opposite the external air channel 40A, and the outflow opening 42E lies opposite the inflow opening 40B.

It should be mentioned that the closure link 42B can also assume, for example, intermediate positions between its open position OP and its closed position SP, so that the amount of the external air F that flows through the external air inlet 140 can be adjusted.

The closure link 42B can also be referred to or viewed as a valve element of a setting valve.

To activate the rotating body 43 or the closure link 42B, an activation element 45 configured in the manner of a handle, for example, can be provided. The activation element 45 has an activation projection 45A, for example, which can be clamped using two fingers of an operator.

Alternatively to the activation element 45, an activation element 46 provided for activation using a tool or aid can also be provided on the closure link 42B. The activation element 46 has a slot 46A that can be activated, for example, using a screwdriver, a coin or the like, so as to adjust the closure link 42B between its closed position SP and its open position OP.

The activation elements 45 or 46 are preferably provided on an end face of the closure link 42B through which the axis of rotation of the closure link 42B passes.

A further alternative for activation of the closure link 42B is represented by an actuator 47, shown schematically, which is a motor and/or electric and/or driven electrically, for example an electric motor, an electromagnet or the like. The actuator 47 can be activated or controlled, for example, using an electric switch and/or a sensor 48. The sensor 48 is connected, for example, to a controller 120 of the hand-held machine tool 10, which controller generates control commands using signals of the sensor 48, in particular for the actuator 47.

The sensor 48 detects, for example, the presence of the dust collection device 70 on the dust removal connector 33. If therefore, the dust collection device 70 is plugged onto the dust removal connector 33, the sensor 48 can detect this and control the actuator 47 to adjust the closure link 42B to its closed position SP. The sensor 48 is, for example, a pressure sensor, an electric switch, an approximation sensor or the like. Of course, an RFID sensor, a magnet, a Hall sensor, an optical sensor or the like can also be provided.

Furthermore, it is conceivable that a schematically shown activation element 49, for example an activation projection, projects away from the closure link 42B, which element can be activated when the dust collection device 70 is plugged onto the dust removal connector 33, so as to activate the closure link 42B in the direction of its closed position SP. For example, a type of entrainment fork is possible as an activation element 49, into which fork an entrainment projection on the dust collection device 70 engages. Thereby it is also possible that the dust collection device 70 again entrains the closure mechanism 41B or the closure link 42B in the direction of the open position OP during removal from the dust removal connector 33.

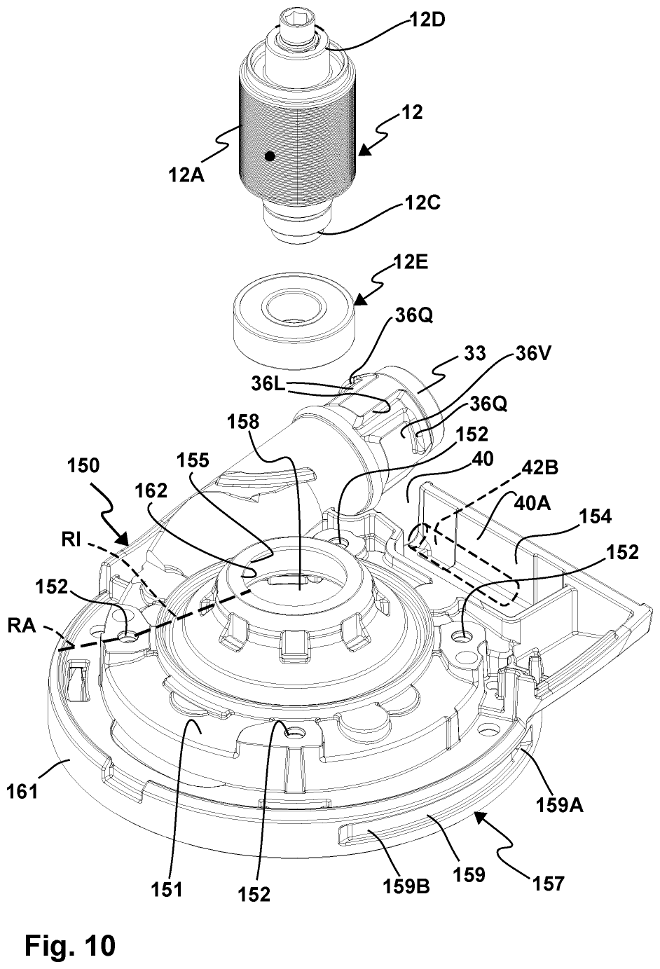

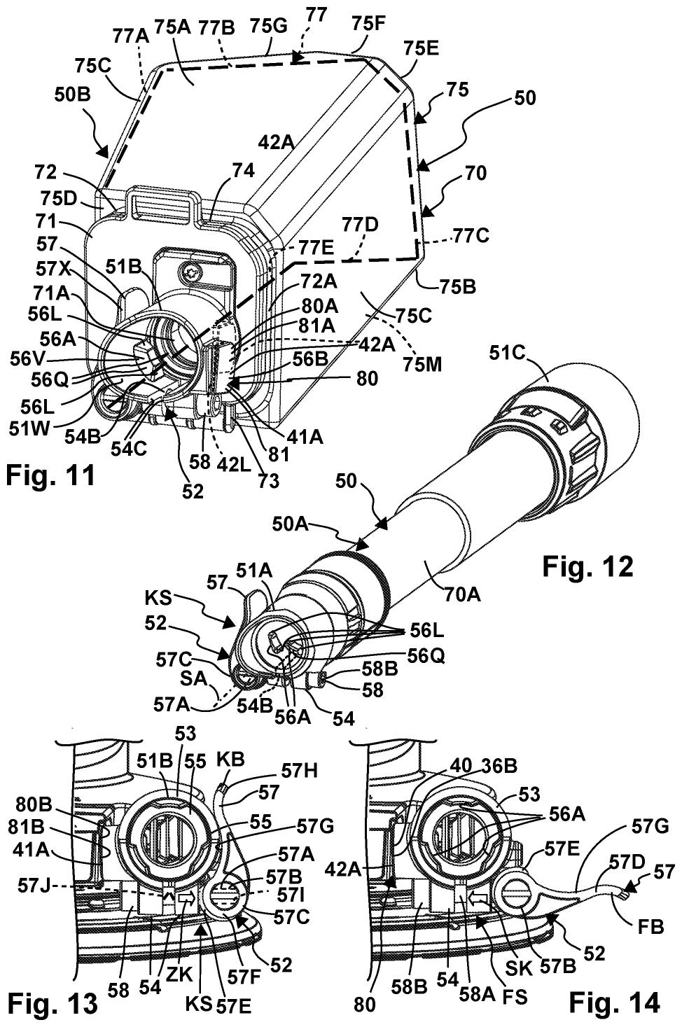

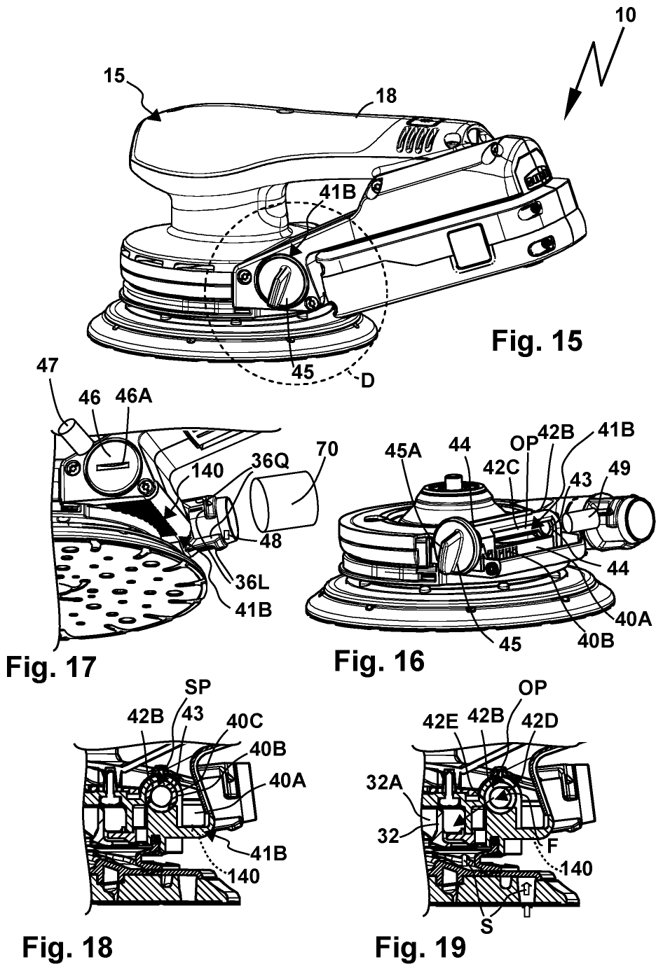

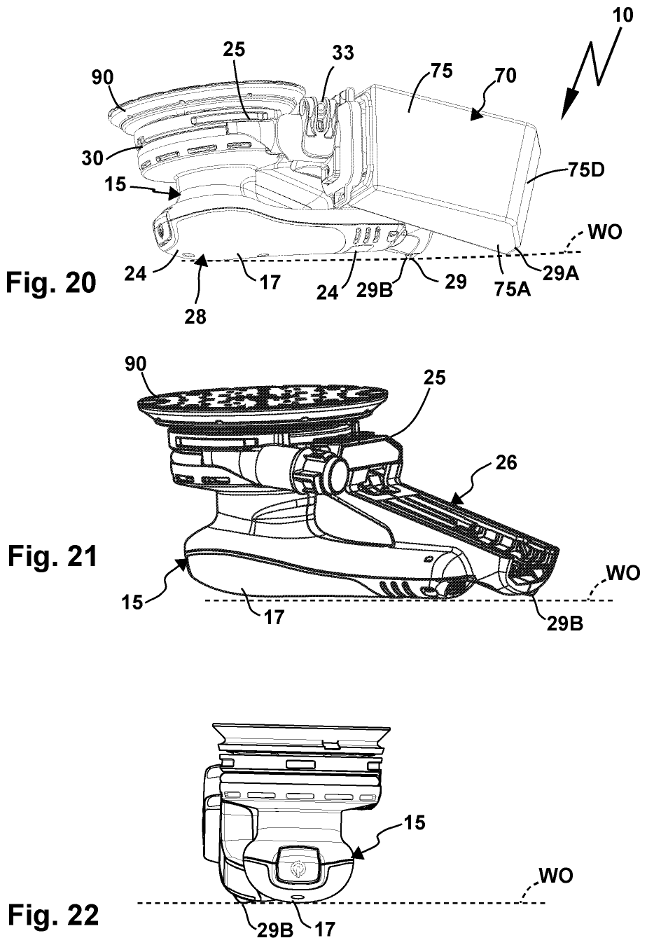

The closure link 42B, in particular in its property as a valve link, can also easily be used in the embodiment according to FIG. 10, where it is drawn schematically in the external air channel 40A. Therefore the closure link 42B could be provided and configured for this purpose, for example, of variably adjusting the external air stream within the external air channel 40A. In addition, the external air channel 40A, in particular the external air inlet 40, can be closed off by means of the closure part 42A of the dust collection device 70, if applicable completely or essentially completely. Thus, for example in the case of operation of the hand-held machine tool 10 without the dust collection device 70, the external air stream can be variably adjustable using the closure link 42B, while with the dust collection device 70 it is completely or partially stopped.

At this point, it should be mentioned that a smaller closure surface, for example, of the closure part 42A is suitable for closing off the external air inlet 40 only partially when the dust collection device 70 is arranged on the hand-held machine tool 10. Furthermore, it is possible that the closure part 42A is movably mounted on the dust collection device 70, for example using a schematically shown bearing 42L, in particular a thrust bearing and/or rotating bearing. For example, the closure part 42A can be adjusted into a position shown upward with broken lines, in which it closes off the external air inlet 40 only partially when the dust collection device 70 is arranged on the hand-held machine tool 10. It is advantageous if the closure part 42A can also be adjusted into intermediate positions between the position shown with a broken line and the position shown with solid lines and/or also into a position that releases the external air inlet 40 even further.

Setting the grinding machine 11 or hand-held machine tool 10 down onto its top side 24 can be done very easily, wherein it plays no role whether or not the dust collection device 70 is attached to the dust removal connector 33. In both situations, the grinding machine 11 can be laid down with its top side 24, for example onto the workpiece surface WO, and supported without then tilting toward the side, for example toward one of the longitudinal sides 21 or 22.

For this purpose, a support contour arrangement 28 is provided. The support contour arrangement 28 comprises the handle section 17 as well as a support contour, for example a projection 29, arranged on the free end region of the energy storage unit connector 26 or of the handle 18. The projection 29 is provided at a transverse distance from the longitudinal center plane 23. If, therefore, the grinding machine 11 or hand-held machine tool 10 is laid down, on its top side 24, onto the substratum, for example the workpiece surface WO, with the dust collection device 70 when this is attached to the dust removal connector 33, it supports itself with the handle section 17, the support contour or the projection 29, as well as a support contour 29A provided on an edge between the rear wall 75D and the side wall 75A of the dust collection container 75, on the substratum or the workpiece surface WO.

If, however, the dust collection device 70 is removed from the dust removal connector 33, it is likewise possible to set the machine housing 15 down or lay it down with its top side 24, in a tilt-proof manner, on the substratum or the workpiece surface WO. Then the hand-held machine tool 10 and/or the machine housing 15 supports itself, for example using the support contour 29, the handle section 17, as well as a support contour 29B provided on the free end region of the handle 18, on the substratum or the workpiece surface WO.

The support contour pairs 29, 29B or 29, 29A are arranged on opposite sides of the longitudinal center plane 23, and furthermore have a longitudinal distance with reference to the handle section 17, so that stable three-point contact of the hand-held machine tool 10 or grinding machine 11 on the substratum or workpiece surface WO is always possible, with and without the dust collection device 70 being arranged on the machine housing 15.

To close off the motor mounting bracket 16A or the motor mounting bracket space 16C that makes the motor mounting bracket 16A available, a bearing support 150 is provided. The bearing support 150 forms a lid 150A.

The bearing support 150 is configured, for example, as a wall body 157, or has a wall body 157.

The bearing support 150 or wall body 157 has, for example, a wall section or a wall 151, which closes off the motor mounting bracket 16A or the motor mounting bracket space 16C.

The rotor 12B of the drive motor 12 is arranged on the motor shaft 12C. The motor shaft 12C is mounted on a motor bearing 12D and a motor bearing 12E, so as to rotate with reference to the machine housing 15.

The motor bearing 12D and the motor bearing 12E are arranged on opposite sides of the rotor 12B or of the motor shaft 12C.

In the region of the top side 24 of the machine housing 15 and/or on a side of the machine housing 15 opposite to the tool holder 14, a bearing holder 16B for the motor bearing 12D is arranged. The bearing holder 16B is arranged, for example, on the motor mounting bracket 16A.

The motor bearing 12E is held on a bearing holder 155 of the bearing support 150. The bearing support 150 and/or the wall body 157 form(s) a support structure 160 that carries the bearing holder 155. The support structure 160 extends with a directional component parallel to the motor axis M, in the direction of the tool holder 14.

The bearing holder 155 is arranged approximately centrally on the bearing support 150 or the wall 151. A ring-shaped bearing holder element 156 is arranged in the bearing holder 155, for example made of steel or the like, which element accommodates the motor bearing 12E. It would easily be possible to support the motor bearing 12E directly on the bearing holder 155, i.e., that the bearing holder element 156 is not present.

Around the bearing holder 155, the bearing support 150 has screw openings 152 through which screws 153 can be inserted, which can be screwed into the machine housing 17. By means of these screws 153 as well as shape-fit contours on the bearing support 150, which contours engage, with shape fit, into matching shape-fit contours of the machine housing 15, the bearing support 150 is held fixed in place with reference to the machine housing 15. Consequently the motor bearing 12E is also held fixed in place with reference to the machine housing 15.

The screw openings 152 are arranged relatively nearby with reference to the motor axis M. For example, the screw openings 152 are spaced apart from an outside circumference 161 of the bearing support 150 with an outer radial distance RA, and spaced apart from an inside circumference 162 of the bearing holder 155 with an inner radial distance RI. It can be seen that the radial distances RA and RI deviate only slightly from one another, for example by maximally 20% or 30% or at most 40%.

The bearing support 150 has a channel section 154 on a side that faces the rear side 20 of the machine housing 15, in which section the external air channel 40A is configured.

Furthermore the accommodation chamber 32A for the dust/air wheel 32 is provided on a side of the bearing support 150 that faces away from the motor mounting bracket space 16C.

The wall 151 is arched or dome-like, for example, so that it forms a bearing support accommodation space 158 that forms the accommodation chamber 32A and/or is suitable for accommodating the dust/air wheel 32.

The bearing support accommodation space 158 or the accommodation chamber 32A for the dust/air wheel 32 is flow-connected to the dust removal connector 33. For example, the accommodation chamber 32A is flow-connected to the removal connection tube 34.

The bearing support 150 is made, for example, of metal or some other solid or rigid material. Therefore the bearing support 150 can have holders 159 for carrying a protective body 38, for example. The holders 159 are arranged, for example, on the outside circumference of the wall 151.

Engagement projections 38A of the protective body 38 can engage, for example, into the holders 159. For example, the holders 159 comprise engagement holders 159A for the engagement projections 38A and/or, in particular, grooves 159B running in ring shape around the motor axis M, into which ring-shaped holding projections or holding contours 38B of the protective body 38 can engage and do engage in the state of the protective body 38 when it is mounted on the bearing support 150.

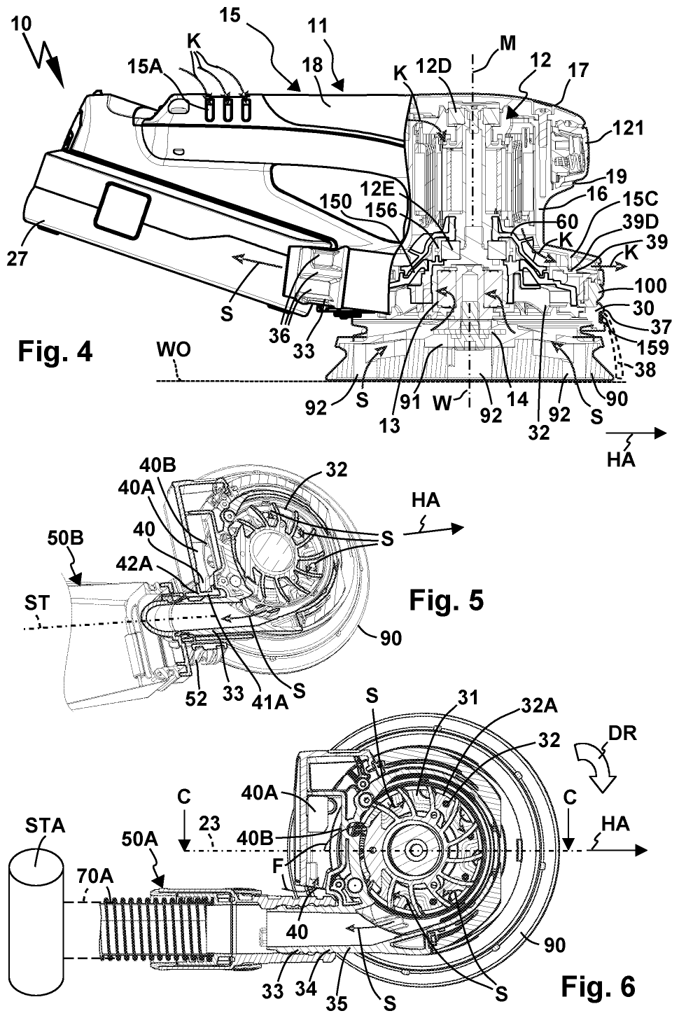

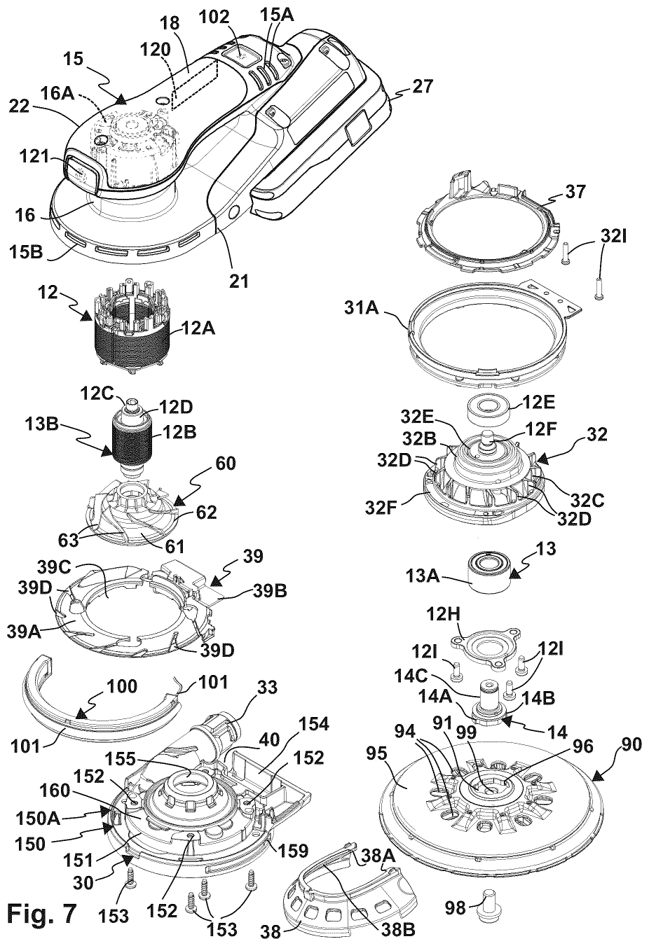

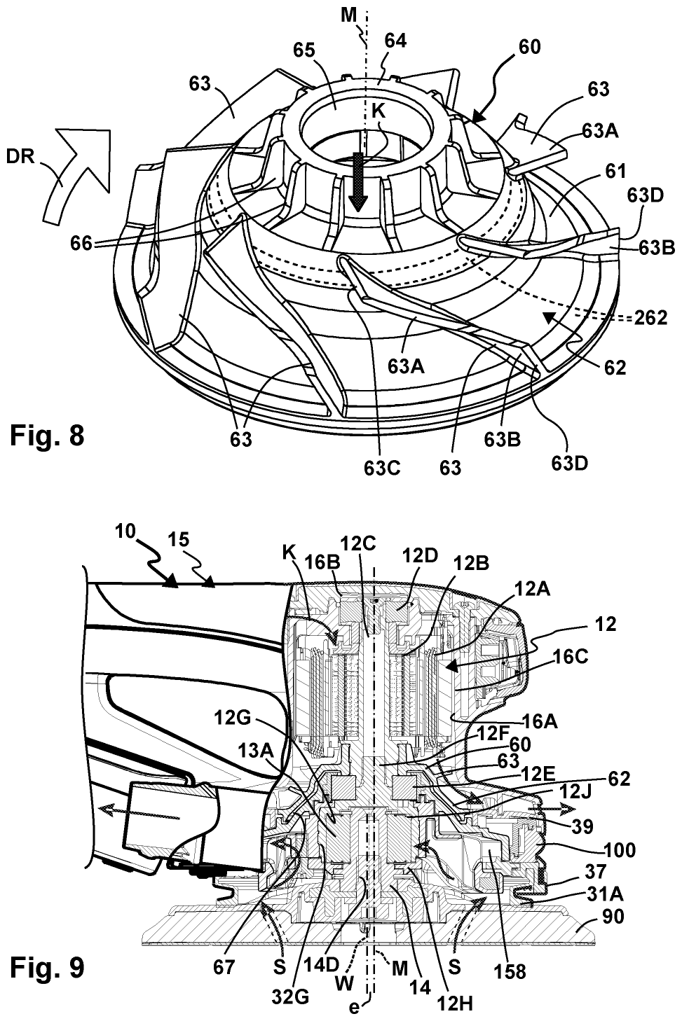

The protective body 38 indicated schematically in FIG. 4 and shown in FIG. 7 in a slightly smaller size serves for protecting a radial outside circumference of the disk tool 90, for example a cushion of the disk tool 90. The protective body 38 protects the disk tool 90, in particular when working in inside corner regions, when narrow sides or circumference sides of the disk tool 9 would bump up against an obstacle. Then the protective body 38 makes contact with this obstacle, so that the disk tool 90 arranged behind the protective body 38 with reference to the obstacle is not damaged. The protective body 38 is configured, for example, in the manner of a ring-shaped or partially ring-shaped circumferential wall, an apron or the like.

The motor bearings 12D and 12E are preferably rolling bearings, in particular roller bearings or ball bearings.

Close to the motor bearing 12E, the motor shaft 12C has a holder element 12F that is connected to the motor shaft 12C in a torque-proof manner or can be in one piece with the motor shaft 12C. The motor bearing 12E is configured, for example, in such a manner that it supports the motor shaft 12C and/or the holder element 12F and/or carries it/them so as to rotate with reference to the motor axis M.

The holder element 12F has a holder 12G in which the gear mechanism 13, for example in the form of the eccentric bearing 13A, is accommodated. The eccentric bearing 13A or gear mechanism 13 is held using a holding body 12H, which is screwed onto the holder element 12F, for example using screws 12I.

The eccentric bearing 13C is a rolling bearing, for example, in particular a ball bearing or roller bearing. The eccentric bearing 13C is eccentric with reference to the motor axis M, wherein the tool axis W has an eccentric distance e relative to the motor axis M.

The tool holder 14, for example a bolt section 14C of the tool holder 14, is accommodated, for example, on a holder 13B of the eccentric bearing 13A or gear mechanism 13, in particular in a press fit and/or using a glued connection and/or the like.

The tool holder 14 is configured for rotational entrainment of the disk tool 90 with reference to the tool axis W. The tool holder 14 comprises, for example, a rotational entrainment section 14A, on the outside circumference of which a rotational entrainment contour 14B is arranged. The rotational entrainment contour 14B fits, with shape fit, into a rotational entrainment contour 96 on the drive holder 91 of the disk tool 90, so that the rotational entrainment contours 14B and 96 in total can connect the disk tool 90 to the holding body 12H, in a torque-proof manner, with reference to the tool axis W.

Furthermore the tool holder 14 has a screw holder 14D, into which a fastening screw 98, which can be inserted through a passage opening 99 of the disk tool 90, can be screwed, so that the disk tool 90 can be connected or is connected to the tool holder 14, in a tension-proof manner, with reference to the tool axis W.

A cooling air wheel 60 is arranged between the dust/air wheel 32 and the drive motor 12.

The cooling air wheel 60 is arranged between the drive motor 12 and the bearing support 150.

The bearing support 150 separates the dust removal space 31 from the motor mounting bracket space 16C. The bearing support 150 can also be referred to as a bulkhead wall or have a bulkhead wall that separates the dust removal space 31 from the motor mounting bracket space 16C or separates the dust removal space 31 from the further interior of the machine housing 15.

The cooling air wheel 60 is connected to the motor shaft 12C in a torque-proof manner. The cooling air wheel 60 serves to produce a cooling air stream K, which flows into the machine housing 15 by way of inflow openings 15A, flows through the motor mounting bracket space 16C, flows around and/or through the drive motor 12, and subsequently flows out of the machine housing 15 by way of outflow openings 15B.

It is advantageous if the inflow openings 15A are arranged away from and at a distance from the tool holder 14 and thereby from the disk tool 90, for example in the longitudinal end region of the handle 18.

It is advantageous if the outflow openings 15B are arranged on the front side 19 of the machine housing 15, above the dust removal space 31 and/or in an outflow direction approximately corresponding to the main working direction HA, so that dust that lies on the workpiece surface WO can be blown away in the main working direction HA by means of the cooling air stream K.

It is advantageous if outflow openings 15B are also provided transverse to the main working direction HA. This measure advantageously reduces the flow resistance for the cooling air stream K and/or allows better purging of the work environment around the hand-held machine tool 10.

The cooling air wheel 60 has a fan section 61. The fan section 61 comprises a support wall 62 from which fan blades 63 project and/or on which fan blades 63 are arranged.

The fan blades 63 can also be held, for example, on ring-shaped carriers 262, preferably ones having different diameters, which are spaced apart from one another with reference to the motor axis M, which carriers can be provided in place of the support wall 62 or supplemental to the support wall 62. The carriers 262 are shown schematically.

The support wall 62 projects away from a holding section 64 of the cooling air wheel 60 or is arranged on the holding section 64.

The holding section 64 has a shaft holder 65 configured as a passage opening, for example, to hold the motor shaft 12C. The holding section 64 is configured, for example, as a cylindrical section or a holding cylinder.

It is advantageous if ribs 66 project away from the holding section 64, which ribs serve, for example, as support ribs and/or contribute to producing or directing the cooling air stream K. It is advantageous if the ribs 66 are oriented parallel to the motor axis M. It is advantageous if flat sides of the ribs 66 extend parallel to the motor axis M.

The cooling air wheel 60 forms an axial/radial fan or diagonal fan. The fan blades 63 are inclined at a slant with regard to the motor axis M.

The fan blades 63 have axial sections 63A and radial sections 63B.

The axial sections 63A can serve to cause the cooling air stream K to flow through and around the drive motor 12. The axial sections 63A ensure an axial flow direction of the cooling air stream K, approximately parallel to the motor axis M or along the motor axis M, onto an intake side of the cooling air wheel 60. The cooling air stream K is drawn in, so to speak, by means of the axial sections 63A.

The axial sections 63A of the fan blades 63 make a transition, in the manner of an interlacing, into the radial sections 63B.

The radial sections 63B advantageously ensure that the cooling air stream K is blown out radially or conveyed away with reference to the motor axis M, so that the cooling air stream K flows out of the motor mounting bracket space 16C by way of the outflow openings 15B.

The axial sections 63A entrain a volume of the cooling air stream K in the direction of the radial sections 63B.

With reference to the direction of rotation DR, the axial sections 63A are inclined relatively flatly. With reference to the direction of rotation DR, the axial sections 63A preferably have an inclination of 30° to 50°, for example, in particular an inclination of about 45°. The axial sections 63A preferably have this inclination also with reference to the motor axis M, which is simultaneously the axis of rotation of the cooling air wheel 60.

With reference to the direction of rotation DR, the axial sections 63A are inclined slightly flatter than the radial sections 63B.

The fan blades 63 have front blade edges or blade front edges 63C or entry edges in the direction of rotation DR, and rear blade edges or blade rear edges 63D or exit edges in the direction of rotation DR.

It is advantageous if the blade front edge 63C is arranged in front of the blade rear edge 63D in the direction of rotation DR.

The entry edge 63C runs, for example, essentially radially relative to the motor axis M. The exit edge 63D, in contrast, runs essentially parallel to the motor axis M.

The fan blades 63, in particular the radial sections 63B, can also, however, be provided for acceleration of the cooling air stream K, in particular in such a manner that, for example, a high differential pressure can be produced, in particular in a diffuser of the hand-held machine tool 10, which follows the radial sections and surrounds the cooling air wheel 60. For example, it is provided that an entry flow cross-section 63E, which extends between fan blades 63 that are arranged one behind the other and/or adjacent, in the direction of rotation DR, between their entry edges 63C, is greater than an exit flow cross-section 63F, which is delimited, among other things, by the exit edges 63D of these fan blades 63.

From the following description, measures will become evident, on the basis of which the grinding machine 11 is particularly compact with reference to its expanse parallel to the tool axis W or motor axis M, although it has a dust/air wheel 32 in its drive train 13B.

Furthermore, the cooling air wheel 60 and the bearing support 150 are preferably configured in such a manner that they can engage all the way into a tapered section 16D of the machine housing 15. The drive motor 12 is accommodated in the tapered section 16D, for example. The tapered section 16D extends between the handle section 17 and the cover 30 and can be fully grasped by an operator, for example. In particular, fingers of an operator can engage into the tapered section 16D when the operator's hand lies on the handle section 17. Furthermore, the reach-through opening 18A is arranged next to the tapered section 16D. Consequently the tapering of the section 16D advantageously contributes to an increase in size of the reach-through opening 18A.

The dome-like or approximately truncated-cone-shaped wall 151, against the top side of which the cooling air wheel 60 clings, so to speak, contributes to a particularly compact construction and/or a low design with reference to the motor axis M or tool axis W.

It is advantageous if it is provided that the sides of cooling air wheel 60 and wall 151 that face one another are configured to match one another and/or have geometric progressions and/or contours that match one another.

The dust/air wheel 32, which also has a dome-like or approximately truncated-cone-shaped contour on its top side, which faces the wall 151, at least in a section that lies opposite the wall 151, is likewise adapted to the wall 151, namely to its underside.

The cooling air wheel 60, in particular the support wall 62, has an approximately bell-shaped and/or dome-like and/or approximately truncated-cone-shaped form, in total. On a side of the support wall 62 that faces away from the fan blades 63, the support wall 62 delimits a cooling air wheel accommodation space 67.

The cooling air wheel accommodation space 67 makes it possible to provide multiple components.

For example, the bearing support 150 is arranged, at least in part, in the cooling air wheel accommodation space 67. In particular, the wall section or the wall 151 extends into the cooling air wheel accommodation space 67. Consequently, a bulkhead wall that separates the dust removal space 31 from the motor mounting bracket space 16C, in the form of the bearing support 150, is arranged in the cooling air wheel accommodation space 67 or an interior of the cooling air wheel 60. The wall section or the wall 151 has an approximately bell-shaped form, at least in the region of the cooling air wheel accommodation space 67, corresponding to the shape of the support wall 62 in the region of the wall 151. For example, flat sides of the wall section or of the wall 151 and of the support wall 62 lie opposite one another in a planar manner.

Furthermore the motor bearing 12E is arranged in the cooling air wheel accommodation space 67. The motor bearing 12E is accommodated completely in the cooling air wheel accommodation space 67. The motor bearing 12E is held on a section of the bearing support 150 arranged in the cooling air wheel accommodation space 67, namely on the bearing holder 155.

Furthermore the gear mechanism 13 and/or the eccentric bearing 13A is/are accommodated, at least in part, in the cooling air wheel accommodation space 67.

The holding body 12H, which holds the gear mechanism 13 or eccentric bearing 13A, is also accommodated, at least in part, in the cooling air wheel accommodation space 67.

The holding body 12H and/or the gear mechanism 13 and/or the eccentric bearing 13A project at least partially beyond the cooling air wheel accommodation space 67 on a side that faces away from the drive motor 12. Nevertheless, a large part, for example approximately half, of the holding body 12H and/or of the gear mechanisms 13 and/or of the eccentric bearing 13A extends into the cooling air wheel accommodation space 67, parallel to the motor axis M.

Finally, a part of the dust/air wheel 32 is also arranged in the cooling air wheel accommodation space 67. For example, a holding section 32B of the dust/air wheel 32 extends into the cooling air wheel accommodation space 67. A fan section 32C, on which fan blades 32D are arranged and which borders on the holding section 32B, projects beyond the cooling air wheel accommodation space 67. The fan blades 32D serve to produce an air stream with reference to the motor axis M or the tool axis W, which stream forms a component of the dust/air stream S.

The dust/air wheel 32 is held on the holder element 12F in a torque-proof manner with reference to the motor axis M.

The dust/air wheel 32 has a holder 32E for the holder element 12F of the motor shaft 12C. The holder element 12F passes through the holder 32E or is held in the holder 32E, in particular held in a torque-proof manner.

The holder 32E forms a dust/air wheel accommodation space 32G, for example to accommodate the gear mechanism 13.

The dust/air wheel 32 has a balance part 32F that serves, for example, for compensation of imbalances brought about by means of the eccentric mounting of the tool holder 14.

The dust/air wheel 32 furthermore engages into an interior or a passage opening of an air guide body 37. The air guide body 37 is configured, for example, as a disk or as a disk-shaped body.

The air guide body 37 is held in a sandwich-like manner between the seal 31A and the bearing support 150. The seal 31A therefore serves to hold the air guide body 37 on the bearing support 150.

The seal 31A is held on the bearing support 150 with screws 32L, for example.

On a side facing away from the dust removal space 31, a cover body 39 is arranged on the bearing support 150. The cover body 39 has a ring-shaped plate section 39A, which surrounds a passage opening 39C, into which the wall section or the wall 151 engages.

A wall section 39B, which covers and closes off the channel section 154, projects away from the plate section 39A.

Furthermore, the cooling air wheel 60 is also arranged in the passage opening 39C or engages into the passage opening 39C. The cover body 39, in particular the plate section 39A, also serves to steer the cooling air stream K. For example, the cooling air stream K can flow along a side of the plate section 39A that faces away from the dust/air wheel 60, and is steered by this side, radially outward with reference to the motor axis M, in the direction of the outflow openings 15B.

Holders 39D are arranged on the plate section 39A, for example on the side along which the cooling air stream K flows. Support ribs or support sections 15C of the machine housing 15 can engage into the holder 39D with shape fit, so that the cover body 39 is held on the machine housing 15 with shape fit, for example in the sense of an anti-rotation unit with reference to the motor axis M and/or as a reinforcement of the machine housing 15.

It is advantageous if the hand-held machine tool 10 has an illumination mechanism 100. The illumination mechanism 100 comprises, for example, a ring-shaped carrier 101, on which lighting elements, in particular LEDs, not shown in the drawing, are arranged.

The installation of the illumination mechanism 100 is simple, in that the illumination mechanism 100 is clamped between the cover body 39 and the air guide body 37. The cover body 39 and/or the air guide body 37 is/are preferably resiliently flexible, so that vibrations that proceed from the drive train 13B, for example, have a lesser or no effect on the illumination mechanism 100.

The illumination mechanism 100 is radially fixed in place with reference to the motor axis M, using the components that hold it, for example the cover body 39 and/or the air guide body 37 and/or the bearing support 150.

It is advantageous if the illumination mechanism 100 is accommodated in a groove that is made available by the components that hold it, for example the cover body 39 and/or the air guide body 37 and/or the bearing support 150.

Furthermore, installation is also very simple because the bearing support 150, when it is fastened to the machine housing 15 with the screws 153, fixes the components arranged between the bearing support 150 and the machine housing 15, among others the cover body 39 and the air guide body 37, as well as the illumination mechanism 100 clamped between these two aforementioned bodies 39 and 37, if applicable, in place with reference to the machine housing 15.

Using a connection cable 102, the illumination mechanism 100 can be connected to a controller 120 of the hand-held machine tool 10 shown schematically in the drawing. A switch 103 serves to turn the illumination mechanism 100 on and off. The switch 103 can be connected directly to the connection cable 102 or connected to the controller 120.

It is advantageous if the controller 120 is arranged in the handle 18. It is practical if the controller 120 is arranged between the inflow openings 15A and the drive motor 12, so that the cooling air stream K that flows in by way of the inflow openings 15A can cool the controller 120.

A further switch 121 serves to turn the drive motor 12 on and off. It is advantageous if the switch 121 is arranged on the front side 19 of the machine housing 15, in particular directly below or next to the handle section 12, so that an operator can easily grasp and activate the switch 121.

1. A dust removal device (50), in particular dust collection device (70), for a hand-held machine tool, in particular a grinding machine (11) or a saw, wherein the dust removal device (50) has a tubular connection body (51A, 51B) for connecting to a tubular dust removal connector (33) of the hand-held machine tool (10), wherein a dust/air stream for conveying away dust that occurs during operation of the grinding machine (11) can flow out of a dust removal space (31) to the dust removal device (50), by way of the dust removal connector (33), wherein the connection body (51A, 51B) has a clamping mechanism (52) for clamping to the dust removal connector (33), wherein the clamping mechanism (52) has an activation element (57X) for activation of the clamping mechanism (52) between a release position (FS) and a clamping position, wherein an accommodation cross-section (55) of the connection body (51A, 51B) for the dust removal connector (33) is smaller in the clamping position for clamping the dust removal connector (33) to the connection body (51A, 51B) than in the release position (FS) that is provided for removing the dust removal device (50) from the dust removal connector (33), wherein the activation element (57X) comprises a pivot lever (57) that is mounted so as to pivot about a pivot axis (SA), between a clamping activation position (KB) assigned to the clamping position and a release activation position (FB) assigned to the release position (FS), about a pivot angle.

2. The dust removal device (50) according to claim 1, wherein the pivot angle is less than 250°, even further preferably less than 180°, even further preferably less than 150°, further preferably less than 120°, even further preferably less than 100°, in particular about 90°.

3. The dust removal device (50) according to claim 1, further comprising a spring mechanism (57J), in particular an elastic body that puts stress on the clamping mechanism (52) in the direction of the release position (FS).

4. The dust removal device (50) according to claim 1, wherein the clamping mechanism (52) comprises a clamping clip (53) or is configured in the manner of a clamping clip (53), or comprises clamping legs (54) that are adjusted toward one another in the clamping position and away from one another in the release position (FS).

5. The dust removal device (50) according to claim 4, wherein the spring mechanism (57J) is arranged between the clamping legs (54) and puts stress on the clamping legs (54) to move them away from one another.

6. The dust removal device (50) according to claim 1, wherein the pivot lever (57) is movement-coupled or connected to at least one tie rod (58), wherein the pivot lever (57) activates the tie rod (58), in the clamping activation position (KB), in the sense of narrowing the accommodation cross-section (55), and/or the tie rod (58) activates clamping legs (54) of the clamping mechanism (52), in the clamping activation position (KB), toward one another.

7. The dust removal device (50) according to claim 1, wherein the pivot lever (57) has an activation contour (57E) for activating the clamping mechanism (52) between the release position (FS) and the clamping position, wherein the activation contour (57E) runs eccentrically relative to the pivot axis (SA) or comprises an eccentric contour (57F).

8. (canceled)

9. The dust removal device (50) according to claim 1, wherein the pivot lever (57) has an accommodation contour (57G) for the connection body (51A, 51B), which contour faces the connection body (51A, 51B), into which contour the connection body (51A, 51B) engages in the clamping activation position (KB).

10. The dust removal device (50) according to claim 1, wherein the pivot lever (57) comprises a handle projection (57G) that projects away, in the clamping activation position (KB), from the connection body (51A, 51B), to be grasped by an operator and to be activated out of the clamping activation position (KB) into the release activation position.

11. The dust removal device (50) according to claim 1, further comprising a suction hose (70A) arranged on the connection body (51A, 51B) and flow-connected to the connection body (51A, 51B), to be connected to a vacuum cleaner (STA).

12. The dust removal device (50) according to claim 1, further comprising a dust collection container (75) for collecting dust, wherein an accommodation space of the dust collection container (75) is flow-connected to the connection body (51A, 51B).

13. The dust removal device (50) according to claim 12, wherein the dust collection container (75) has a flexible dust container as well as a support body (77) for supporting the dust container in an accommodation position in which the dust container is stretched out or held open and suitable for accommodating dust, wherein the support body has a support body longitudinal section (77A) that extends away from the connection body (51A, 51B), and a support body transverse section (77B) that runs transverse to the support body longitudinal section (77A), wherein the support body is arranged on the connection body (51A, 51B) in such a manner that the support body longitudinal section (77A) runs, in the state when the dust removal device (50) is mounted on the hand-held machine tool (10), on a side facing away from a handle (18) and/or energy storage unit of the hand-held machine tool (10), and the support body transverse section (77B) faces the handle (18) and/or energy storage unit (27).

14-15. (canceled)

16. The dust removal device (50) according to claim 1, wherein at least one shape-fit contour (56B) for engagement into a counter-shape-fit contour (36B) of the dust removal connector (33) is provided on the connection body (51A, 51B), or a counter-shape-fit contour (36B) arranged on the dust removal connector (33) is provided.

17. The dust removal device (50) according to claim 16, wherein the at least one shape-fit contour (56A, 56B) comprises at least one shape-fit projection that projects into the accommodation cross-section (55) of the connection body (51A, 51B) and/or an inside circumference wall surface (51B) of the connection body (51A, 51B), and/or the at least one shape-fit contour (56A, 56B) comprises at least one shape-fit projection that projects, outside of the accommodation cross-section (55) of the connection body (51A, 51B), in particular radially with reference to a plug-in axis (ST) provided for plugging the connection body (51A, 51B) onto the dust removal connector (33), outward beyond the connection body (51A, 51B).

18. The dust removal device (50) according to claim 16, wherein the at least one shape-fit contour (56A, 56B) has at least one transverse shape-fit contour (56Q) that runs transverse to an axis, in particular a plug-in axis (ST) for plugging the connection body (51A, 51B) onto the dust removal connector (33), and is configured and provided for tightly holding the connection body (51A, 51B) on the dust removal connector (33), with reference to the axis, and/or has at least one longitudinal shape-fit contour (50 L) that runs parallel or with a directional component parallel to an axis, in particular a plug-in axis (ST) for plugging the connection body (51A, 51B) onto the dust removal connector (33), and is configured and provided as an anti-rotation unit for torque-proof holding of the connection body (51A, 51B) on the dust removal connector (33), with reference to the axis.

19. The dust removal device (50) according to claim 1, further comprising a closure part (42A), in particular one formed by a shape-fit contour (56A, 56B) or the at least one shape-fit contour (56A, 56B), for an external air inlet (40) of the hand-held machine tool (10), for letting external air (F) into the dust removal space (31), wherein the external air inlet (40) is arranged next to the dust removal connector (33) or upstream from the dust removal connector (33).

20. The dust removal device (50) according to claim 16, wherein the at least one shape-fit contour (56A, 56B) forms an anti-rotation unit contour (81) that counteracts rotation of the dust removal device (50) on the dust removal connector (33) or prevents rotation of the dust removal device (50) with reference to the dust removal connector (33).

21. The dust removal device (50) according to claim 1, wherein the dust removal device (50) has a plug-in guide contour (80), in particular comprising the at least one shape-fit contour (56A, 56B) or formed by the at least one shape-fit contour (56A, 56B), for guiding the connection body (51A, 51B) on the dust removal connector (33) in a torque-proof manner with reference to the plug-in axis (ST).

22. The dust removal device (50) according to claim 16, wherein the at least one shape-fit contour (56A, 56B) is provided and configured for the purpose that when it the at least one shape-fit contour (56A, 56B) engages into the counter-shape-fit contour (36, 36B) of the hand-held machine tool (10), the at least one shape-fit contour (56A, 56B) holds the dust removal device (50) with shape fit and tightly, with reference to the plug-in axis (ST), on the dust removal connector (33).

23. A hand-held machine tool (10) having a dust removal connector (33) as well as a dust removal device (50) according to claim 1, wherein the dust removal device (50) can be connected to the dust removal connector (33), in particular that the hand-held machine tool (10) has a counter-shape-fit contour (36B) arranged on the dust removal connector (33), for a or the shape-fit contour (56A, 56B) of the dust removal device (50).
